(19) United States
(12) Patent Application Publication
(10) Pub. No.: US 2021/0112149 A1
(43) Pub. Date: Apr. 15, 2021

(54) TERMINAL

(71) Applicant: VIVO MOBILE COMMUNICATION CO., LTD., Guangdong (CN)

(72) Inventor: Yuzhong LI, Guangdong (CN)

(21) Appl. No.: 17/130,017

(22) Filed: Dec. 22, 2020

Related U.S. Application Data
(63) Continuation of application No. PCT/CN2019/092035, filed on Jun. 20, 2019.

(30) Foreign Application Priority Data
Jun. 27, 2018 (CN) 201810678425.6

(51) Int. Cl. H04M 1/02

(52) U.S. Cl. CPC H04M 1/0216

(57) ABSTRACT

A terminal is provided, including: a first sub-part, a second sub-part, at least two first flipping bands and at least one second flipping band. A first end of the first band is attached to a first lengthwise edge of a screen of first sub-part, a second end of the first band is attached to a second lengthwise edge of a screen of second sub-part. A first end of the second band is attached to a first lengthwise edge of the screen of second sub-part, a second end of the second band is attached to a second lengthwise edge of the screen of first sub-part. The bands are alternately arranged. When the terminal is unfolded, the screens of the sub-parts are coplanar, the first band fits onto an outer surface of the first or second sub-part, and the second band fits onto an outer surface of the second or first sub-part.

### CROSS-REFERENCE TO RELATED APPLICATION

This application is a continuation application of PCT Application No. PCT/CN2019/092035 filed on Jun. 20, 2019, which claims a priority to Chinese Patent Application No. 201810678425.6 filed in China on Jun. 27, 2018, the disclosure of which is incorporated in its entirety by reference herein.

### TECHNICAL FIELD

The present disclosure relates to the field of terminal technology, in particular to a terminal.

### BACKGROUND

With development of technologies, in order to better meet user demands, foldable devices have emerged. Taking a mobile phone as an example, all the foldable device solutions in the related art provide a rotation shaft and hinge mechanism between two sub-parts to realize folding of a foldable screen, as shown in FIG. 1 and FIG. 2.

However, since the foldable device design in the related art has the rotation shaft, there is a large gap at the joint and the gap is difficult to be made narrower, as a result, the foldable device has a crude appearance. Moreover, the foldable device occupies a large space, and an overall thickness thereof is difficult to reduce. The rotation shaft has a complex mechanism and is difficult to manufacture, leading to increased production cost. Further, the foldable device relies on the rotation shaft and the hinge to perform folding and flipping, and the folding and flipping can only be performed at the position of the rotation shaft, leading to a monotonous product operating mode.

### SUMMARY

A terminal, includes: a first sub-part, a second sub-part, at least two first flipping bands and at least one second flipping band. A first end of each of the at least two first flipping bands is attached to a first lengthwise side edge of a screen of the first sub-part, and a second end of each of the at least two first flipping bands is attached to a second lengthwise side edge of a screen of the second sub-part. A first end of each of the at least one second flipping band is attached to a first lengthwise side edge of the screen of the second sub-part, and a second end of each of the at least one second flipping band is attached to a second lengthwise side edge of the screen of the first sub-part; the second flipping band and the first flipping band are alternately arranged. When the terminal is in an unfolded state, the screen of the first sub-part and the screen of the second sub-part are coplanar, each of the at least two first flipping bands fits snugly onto an outer surface of the first sub-part or an outer surface of the second sub-part, and each of the at least one second flipping band fits snugly onto the outer surface of the second sub-part or the outer surface of the first sub-part. The outer surface is a surface of the first sub-part or the second sub-part that is arranged opposite to a corresponding screen and connects a first lengthwise side edge and a second lengthwise side edge of the corresponding screen.

### BRIEF DESCRIPTION OF THE DRAWINGS

FIG. 1 is a first schematic structural diagram of a foldable terminal in the related art;

FIG. 2 is a second schematic structural diagram of a foldable terminal in the related art;

FIG. 3 is a schematic structural diagram of a terminal according to an embodiment of the present disclosure;

FIG. 4 is a schematic structural diagram of a first flipping band or a second flipping band according to an embodiment of the present disclosure;

FIG. 5 is a schematic diagram of a terminal in a folded state according to an embodiment of the disclosure;

FIG. 6 is a schematic diagram of a terminal in an unfolded and opened state according to an embodiment of the disclosure;

FIG. 7 is a schematic diagram of a terminal when opened from a right side according to an embodiment of the disclosure;

FIG. 8 is a schematic diagram of a terminal when opened from a left side according to an embodiment of the disclosure;

FIG. 9 is a schematic diagram illustrating a left-to-right flipping process of a terminal according to an embodiment of the disclosure.

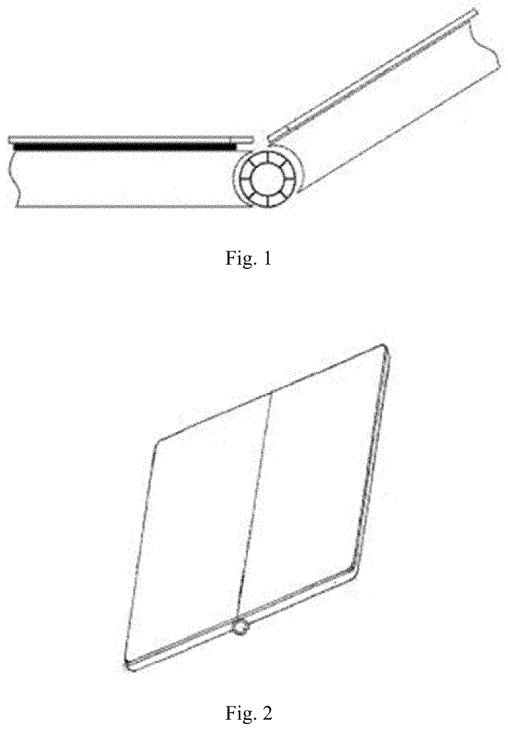

### DETAILED DESCRIPTION

The technical solutions in the embodiments of the present disclosure will be described hereinafter clearly with reference to the drawings of the embodiments of the present disclosure. Obviously, the described embodiments are merely a part of, rather than all of, the embodiments of the present disclosure, and based on these embodiments, a person of ordinary skill in the art may, without any creative effort, obtain other embodiments, which also fall within the scope of the present disclosure.

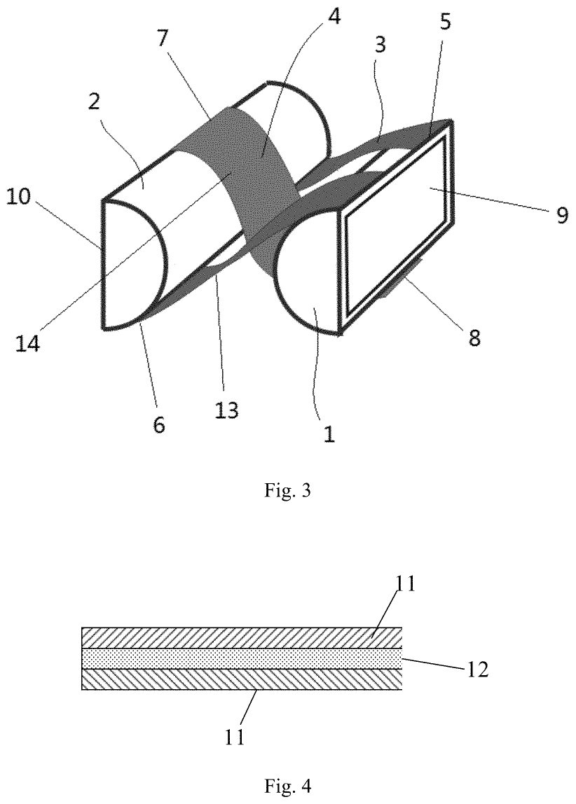

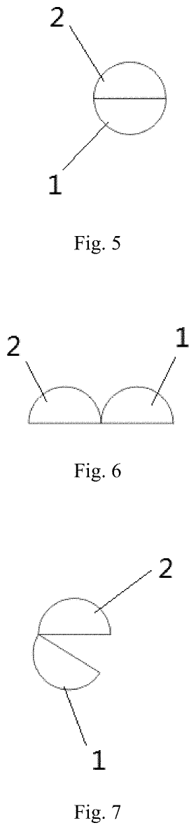

In view of the problems of crude appearance, high production cost, large overall thickness, and monotonous folding and flipping mode of a foldable terminal in the related art, a terminal is provided in the present disclosure. As shown in FIG. 3 to FIG. 9, the terminal includes a first sub-part 1, a second sub-part 2, at least two first flipping bands 3 and at least one second flipping band 4.

A first end 5 of each of the at least two first flipping bands 3 is attached to a first lengthwise side edge of a screen of the first sub-part 1, and a second end 6 of each of the at least two first flipping bands 3 is attached to a second lengthwise side edge of a screen of the second sub-part 2.

A first end 7 of each of the at least one second flipping band 4 is attached to a first lengthwise side edge of the screen of the second sub-part 2, and a second end 8 of each of the at least one second flipping band 4 is attached to a second lengthwise side edge of the screen of the first sub-part 1. The second flipping band 4 and the first flipping band 3 are alternately arranged.

When the terminal is in an unfolded state, the screen 9 of the first sub-part 1 and the screen 10 of the second sub-part 2 are coplanar, each of the at least two first flipping bands 3 fits snugly onto an outer surface of the first sub-part 1 or the second sub-part 2, and each of the at least one second flipping band 4 fits snugly onto an outer surface of the second sub-part 2 or the first sub-part 1.

The outer surface is a surface of the first sub-part 1 or the second sub-part 2 that is arranged opposite to a corresponding screen and connects a first lengthwise side edge and a second lengthwise side edge of the corresponding screen (the outer surface of the first sub-part is a surface of the first sub-part that is arranged opposite to the screen of the first sub-part and connects the first lengthwise side edge and the second lengthwise side edge of the screen of the first sub-part; the outer surface of the second sub-part is a surface of the second sub-part that is arranged opposite to the screen of the second sub-part and connects the first lengthwise side edge and the second lengthwise side edge of the screen of the second sub-part).

In the embodiment of the present disclosure, by using the first flipping band and the second flipping band to join the first sub-part and the second sub-part, a split type shaftless foldable screen terminal that may be flipped and folded on both sides is realized. The folding and unfolding is realized by using a foldable device design enabling shaftless flipping and folding, thereby reducing manufacturing difficulty and saving production cost. A fit clearance in a flipped and folded state is reduced, which may improve fineness and delicacy of products. Moreover, there is no rotation shaft to occupy a thickness and width space, the overall thickness may be smaller. The terminal may also be folded and flipped on the left and right sides, thus the folding and flipping can be performed in a variety of modes, freely without constraint, and an exterior color of the product may be switched between two colors depending on a flipping and folding direction. Two screens (screens of two sub-parts) are joined together to form a large flat screen when the device is unfolded, and the two sub-parts are clamped tightly together when the device is fully folded, with the two screens being stacked in between and well protected from being broken or scratched. In addition, the two screens may be joined together to act as a large flat screen, or one of the two screens may be used alone. All the folded and flipped states present integral appearance effects, and there is no extra protruding shape. Thus, the problems of crude appearance, high production cost, large overall thickness, and monotonous folding and flipping mode of the foldable terminal in the related art are adequately solved.

When the terminal is in a closed state, the screen of the first sub-part and the screen of the second sub-part are adjacently arranged in parallel, the first flipping band fits snugly onto the outer surface of the first sub-part or the second sub-part, and the second flipping band fits snugly onto the outer surface of the second sub-part or the first sub-part.

As shown in FIG. 3 and FIG. 4, each of the first flipping band 3 and the second flipping band 4 includes two reinforcing protective layers 11 and a flexible printed circuit layer 12 arranged between the two reinforcing protective layers 11, and the flexible printed circuit layer 12 includes a data line for transmitting data and a power line for transmitting electrical power.

Thus, it may be ensured that transmission of electric power and data is achieved while the flipping of the sub-parts is enabled.

As shown in FIG. 3, in embodiments of the present disclosure, a quantity of the first flipping bands 3 may be two, a quantity of the second flipping band 4 may be one, the second flipping band 4 is arranged between the two first flipping bands 3, and a distance from a center line of one of the two first flipping bands 3 to a center line of the second flipping band 4 is equal to a distance from a center line of the other one of the two first flipping bands 3 to the center line of the second flipping band 4.

In this way, it may be ensured that resources may be saved as much as possible (by using as few flipping bands as possible) while the flipping of the sub-parts is enabled, to ensure the smooth realization of sub-part flipping.

As shown in FIG. 3, a sum of widths of the first ends 5 of the first flipping bands 3 and a width of the first end 7 of the second flipping band 4 is equal to a length of the first lengthwise side edge of the screen 9 of the first sub-part 1, and the length of the first lengthwise side edge of the screen 9 of the first sub-part 1 is equal to a length of the first lengthwise side edge of the screen 10 of the second sub-part 2.

A sum of widths of the second ends 6 of the first flipping bands 3 and a width of the second end 8 of the second flipping band 4 is equal to a length of the second lengthwise side edge of the screen 9 of the first sub-part 1, and the length of the second lengthwise side edge of the screen 9 of the first sub-part 1 is equal to a length of the second lengthwise side edge of the screen 10 of the second sub-part 2.

In this way, strength of the flipping band may be ensured to a certain extent (by increasing the width of the flipping band as much as possible), so as to prolong a service life.

As shown in FIG. 3, the outer surfaces of the first sub-part 1 and the second sub-part 2 both are arc-shaped surfaces.

In this way, the flipping of the sub-parts and the snug fit between the flipping band and the sub-parts are facilitated, so as to ensure safe usage.

As shown in FIG. 3, a shape of the outer surface of the first sub-part 1 is consistent with a shape of the outer surface of the second sub-part 2, and a developed length of the outer surface of the first sub-part 1 is equal to a developed length of the outer surface of the second sub-part 2.

In this way, it is more convenient to design the flipping bands, that is, the identical flipping bands may be used.

As shown in FIG. 3, a length of a non-fixed portion 13 of the first flipping band 3 is equal to the developed length of the outer surface of the first sub-part 1 or the second sub-part 2. A length of a non-fixed portion 14 of the second flipping band 4 is equal to the developed length of the outer surface of the first sub-part 1 or the second sub-part 2. The non-fixed portion 13 of the first flipping band 3 refers to a freely movable portion other than the first end 5 attached to the first side edge of the first sub-part 1 and the second end 6 attached to the second side edge of the second sub-part 2. The non-fixed portion 14 of the second flipping band 4 refers to a freely movable portion other than the first end 7 attached to the first side edge of the second sub-part 1 and the second end 8 attached to the second side edge of the first sub-part 1.

In this way, sufficient flipping of the sub-parts may be ensured, to avoid that the sub-parts cannot be flipped into place due to an insufficient length of the flipping bands.

As shown in FIG. 3, the first end 5 of the first flipping band 3 is embedded between the screen 9 and the outer surface of the first sub-part 1, and is attached to the first lengthwise side edge of the screen of the first sub-part 1, and/or the second end 6 of the first flipping band 3 is embedded between the screen 10 and the outer surface of the second sub-part 2, and is attached to the second lengthwise side edge of the screen 10 of the second sub-part 2.

In this way, a connection strength of the first flipping band may be ensured, so as to prevent the first flipping band from being separated from the first sub-part or the second sub-part during usage due to an unreliable connection.

As shown in FIG. 3, the first end 7 of the second flipping band 4 is embedded between the screen 10 and the outer surface of the second sub-part 2, and is attached to the first lengthwise side edge of the screen of the second sub-part 2, and/or the second end 8 of the second flipping band 4 is embedded between the screen 9 and the outer surface of the first sub-part 1, and is attached to the second lengthwise side edge of the screen 9 of the first sub-part 1.

In this way, a connection strength of the second flipping band may be ensured, so as to prevent the second flipping band from being separated from the first sub-part or the second sub-part during usage due to an unreliable connection.

The terminal in the embodiment of the present disclosure will be further described below by taking a case in which there are two first flipping bands and one second flipping band, and the outer surfaces of the first sub-part and the second sub-part both are arc-shaped surfaces as an example.

In view of the above problems, a terminal is provided in the embodiment of the present disclosure, thereby a split type shaftless foldable screen electronic device design that may be flipped and folded on both sides is realized. The folding and unfolding is realized by using a foldable device design enabling shaftless flipping and folding, thereby reducing manufacturing difficulty and saving production cost. A fit clearance in a flipped and folded state is reduced, which may improve fineness and delicacy of products. Moreover, there is no rotation shaft to occupy a thickness and width space, the overall thickness may be smaller. The terminal may also be folded and flipped on the left and right sides, thus the folding and flipping can be performed in a variety of modes, freely without constraint, and an exterior color of the product may be switched between two colors depending on a flipping and folding direction. Two screens are joined together to form a large flat screen when the device is unfolded, and the two sub-parts are clamped tightly together when the device is fully folded, with the two screens being stacked in between and well protected from being broken or scratched. In addition, the two screens may be joined together to act as a large flat screen, or one of the two screens may be used alone. All the folded and flipped states present integral appearance effects, and there is no extra protruding shape.

Specifically, as shown in FIG. 3 to FIG. 9, the connection between the two sub-parts is accomplished by flipping bands (the first flipping bands 3 and the second flipping band 4) each composed of the flexible printed circuit (Flexible Printed Circuit, FPC) layer 12 and the reinforcing protective layers 11 arranged on front and back surfaces of the FPC layer. Two ends of the flipping bands are fixed to backside edges of housings of the two sub-parts: two ends of flipping bands on both sides are fixed to a side section of a lower edge of an upper housing and a side section of an upper edge of a lower housing respectively, and two ends of a middle flipping band are fixed to a middle section of an upper edge of the upper housing and a middle section of a lower edge of the lower housing respectively (the first ends 5 of the first flipping bands 3 are attached to the first lengthwise side edge of the screen of the first sub-part 1, and the second ends 6 of the first flipping bands 3 are attached to the second lengthwise side edge of the screen of the second sub-part 2; the first end 7 of the second flipping band 4 is attached to the first lengthwise side edge of the screen of the second sub-part 2, and the second end 8 of the second flipping band 4 is attached to the second lengthwise side edge of the screen of the first sub-part 1; the second flipping band 4 and the first flipping band 3 are alternately arranged), then the terminal may be flipped on both sides.

The lengths of the flipping bands are related to the developed lengths of exterior surfaces of the sub-parts. In a practical product, the sub-parts are tightly bonded and cannot be pulled apart. FIG. 3 is a schematic view illustrating a situation in which the sub-parts are pulled apart, and three such flipping bands are shown. The flipping bands fit snugly onto and follow the surfaces of respective sub-parts to roll and flip, to realize the open and close of the two screens. The shaftless flipping band is very thin and occupies a small width space. When the terminal is unfolded, a gap between two screens joined together is very small, thereby improving fineness and delicacy of the appearance significantly.

That is, the two sub-parts are attached with the flipping bands to form an integral foldable device. The flipping band has the FPC layer and the two reinforcing protective layers, where the FPC layer transmits data and electrical power to enable an interaction between the two sub-parts. Two ends of the flipping band may be fixed to different side edges of the first sub-part 1 and the second sub-part 2 respectively (as shown in FIG. 3).

The flipping bands may divide a width of a lengthwise edge of the sub-part into three equal portions (i.e., the width of the first flipping band is equal to the width of the second flipping band, and a sum of widths of three flipping bands is equal to the length of the side edge of the sub-part), but the present disclosure is not limited thereto.

In the embodiment of the present disclosure, both the first sub-part 1 and the second sub-part 2 may be freely flipped, and the flipping bands fit snugly onto the exterior surfaces of respective sub-parts when the sub-parts are flipped (the first flipping band 3 fits snugly onto the outer surface of the first sub-part 1 or the second sub-part 2, the second flipping band 4 fits snugly onto the outer surface of the second sub-part 2 or the first sub-part 1), and movement trajectories of the exterior surfaces of the two sub-parts follow contours of the exterior surfaces of the sub-parts. The contour is not limited to circular.

When the two sub-parts are flipped, the exterior surfaces of the sub-parts and the flipping bands fit together closely and move synchronously. Since the flipping bands are separately fixed at two ends to an inner edge of one sub-part and an outer edge of the other sub-part (the first ends 5 of the first flipping bands 3 are attached to the first lengthwise side edge of the screen of the first sub-part 1, and the second ends 6 of the first flipping bands 3 are attached to the second lengthwise side edge of the screen of the second sub-part 2; the first end 7 of the second flipping band 4 is attached to the first lengthwise side edge of the screen of the second sub-part 2, and the second end 8 of the second flipping band 4 is attached to the second lengthwise side edge of the screen of the first sub-part 1; the second flipping band 4 and the first flipping band 3 are alternately arranged), during movement, the two outer side flipping bands (the first flipping bands 3) and the one middle flipping band (the second flipping band 4) move in opposite directions and fit snugly onto the exterior surfaces of the two sub-parts, to hold the two sub-parts without being scattered.

In the embodiments of the present disclosure, the flipping bands have the functions of transmitting data and electrical power between the two sub-parts, binding the sub-parts, and flipping the sub-parts. Moreover, the first flipping band and the second flipping band may have different colors, to achieve two sets of exterior colors for a single device.

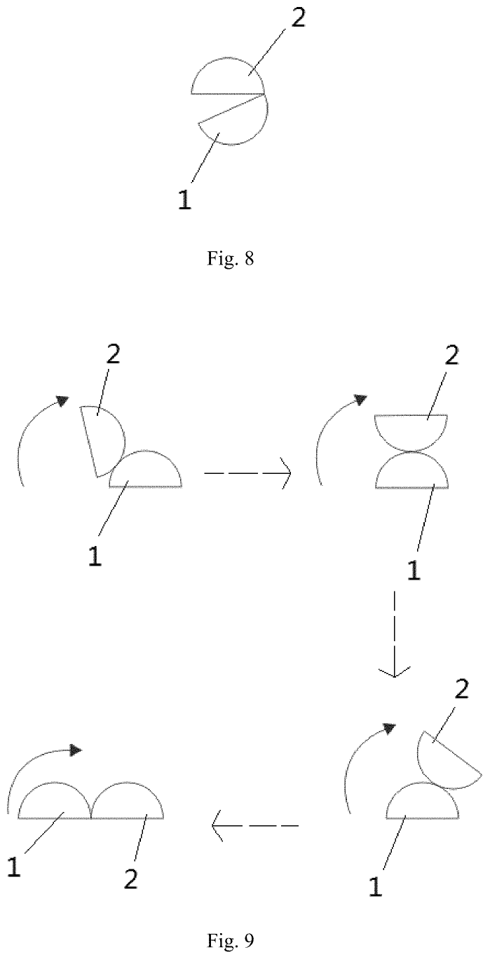

The lengths of the flipping bands are related to the developed lengths of the exterior surfaces of the sub-parts. Due to reverse binding of the flipping bands, a terminal in the folded state may be opened on both the left side and the right side (as shown in FIG. 7 and FIG. 8), and will not be constrained.

The embodiments of the present disclosure are described above with reference to the accompanying drawings, but the present disclosure is not limited to the above-mentioned specific implementations. The above-mentioned specific implementations are merely for illustrative purposes and are not limitative. In light of the present disclosure, those of ordinary skill in the art may, without departing from the gist of the present disclosure and the scope of the claims, make various forms. The various forms also fall within the scope of the present disclosure.

What is claimed is:

1. A terminal, comprising:
a first sub-part, a second sub-part, at least two first flipping bands and at least one second flipping band;
wherein a first end of each of the at least two first flipping bands is attached to a first lengthwise side edge of a screen of the first sub-part, and a second end of each of the at least two first flipping bands is attached to a second lengthwise side edge of a screen of the second sub-part;
a first end of each of the at least one second flipping band is attached to a first lengthwise side edge of the screen of the second sub-part, and a second end of each of the at least one second flipping band is attached to a second lengthwise side edge of the screen of the first sub-part; the second flipping band and the first flipping band are alternately arranged;
when the terminal is in an unfolded state, the screen of the first sub-part and the screen of the second sub-part are coplanar, each of the at least two first flipping bands fits snugly onto an outer surface of the first sub-part or an outer surface of the second sub-part, and each of the at least one second flipping band fits snugly onto the outer surface of the second sub-part or the outer surface of the first sub-part;
wherein the outer surface is a surface of the first sub-part or the second sub-part that is arranged opposite to a corresponding screen and connects a first lengthwise side edge and a second lengthwise side edge of the corresponding screen.

2. The terminal according to claim 1, wherein each of the at least two first flipping bands and the at least one second flipping band comprises two reinforcing protective layers and a flexible printed circuit layer arranged between the two reinforcing protective layers.

3. The terminal according to claim 1, wherein a quantity of the at least two first flipping bands is two, a quantity of the at least one second flipping band is one, the second flipping band is arranged between the two first flipping bands, and a distance from a center line of one of the two first flipping bands to a center line of the second flipping band is equal to a distance from a center line of the other one of the two first flipping bands to the center line of the second flipping band.

4. The terminal according to claim 1, wherein a sum of widths of the first ends of the at least two first flipping bands and a width of the first end of the at least one second flipping band is equal to a length of the first lengthwise side edge of the screen of the first sub-part; and the length of the first lengthwise side edge of the screen of the first sub-part is equal to a length of the first lengthwise side edge of the screen of the second sub-part;
a sum of widths of the seconds end of the at least two first flipping bands and a width of the second end of the at least one second flipping band is equal to a length of the second lengthwise side edge of the screen of the first sub-part; and the length of the second lengthwise side edge of the screen of the first sub-part is equal to a length of the second lengthwise side edge of the screen of the second sub-part.

5. The terminal according to claim 3, wherein a sum of widths of the first ends of the at least two first flipping bands and a width of the first end of the at least one second flipping band is equal to a length of the first lengthwise side edge of the screen of the first sub-part; and the length of the first lengthwise side edge of the screen of the first sub-part is equal to a length of the first lengthwise side edge of the screen of the second sub-part;
a sum of widths of the seconds end of the at least two first flipping bands and a width of the second end of the at least one second flipping band is equal to a length of the second lengthwise side edge of the screen of the first sub-part; and the length of the second lengthwise side edge of the screen of the first sub-part is equal to a length of the second lengthwise side edge of the screen of the second sub-part.

6. The terminal according to claim 1, wherein the outer surfaces of the first sub-part and the second sub-part both are arc-shaped surfaces.

7. The terminal according to claim 1, wherein a shape of the outer surface of the first sub-part is consistent with a shape of the outer surface of the second sub-part, and a developed length of the outer surface of the first sub-part is equal to a developed length of the outer surface of the second sub-part.

8. The terminal according to claim 7, wherein a length of a non-fixed portion of each of the at least two first flipping bands is equal to the developed length of the outer surface of the first sub-part or the second sub-part; and
a length of a non-fixed portion of each of the at least one second flipping band is equal to the developed length of the outer surface of the first sub-part or the second sub-part;
wherein, the non-fixed portion of each of the at least two first flipping bands refers to a freely movable portion other than the first end attached to the first side edge of the first sub-part and the second end attached to the second side edge of the second sub-part;
the non-fixed portion of each of the at least one second flipping band refers to a freely movable portion other than the first end attached to the first side edge of the second sub-part and the second end attached to the second side edge of the first sub-part.

9. The terminal according to claim 1, wherein the first end of each of the at least two first flipping bands is embedded between the screen and the outer surface of the first sub-part, and is attached to the first lengthwise side edge of the screen of the first sub-part; and/or
the second end of each of the at least two first flipping bands is embedded between the screen and the outer surface of the second sub-part, and is attached to the second lengthwise side edge of the screen of the second sub-part.

10. The terminal according to claim 1, wherein the first end of each of the at least one second flipping band is embedded between the screen and the outer surface of the second sub-part, and is attached to the first lengthwise side edge of the screen of the second sub-part; and/or
the second end of each of the at least one second flipping band is embedded between the screen and the outer surface of the first sub-part, and is attached to the second lengthwise side edge of the screen of the first sub-part.

11. The terminal according to claim 2, wherein the flexible printed circuit layer comprises a data line for transmitting data and a power line for transmitting electrical power.
